(19) United States
(12) Patent Application Publication
(10) Pub. No.: US 2021/0258845 A1
(43) Pub. Date: Aug. 19, 2021

(54) WIRELESS COMMUNICATION SYSTEM

(71) Applicant: HONDA MOTOR CO., LTD., Tokyo (JP)

(72) Inventor: Masaru Otaka, Saitama (JP)

(21) Appl. No.: 17/252,199

(22) PCT Filed: May 28, 2019
(86) PCT No.: PCT/JP2019/021045

§ 371 Date: Dec. 14, 2020

(30) Foreign Application Priority Data
Jun. 18, 2018 (JP) 2018-115314

(51) Int. Cl. H04W 36/08; H04W 36/32

(52) U.S. Cl. CPC H04W 36/08; H04W 36/32

(57) ABSTRACT

A wireless communication system is provided that can increase the probability of handover success between a mobile station and a base station and can enhance the merchantability. In a wireless communication system (1) in which a mobile station (10) executes wireless communication with a stationary base station (20) and executes handover with a base station (20) different from the base station (20) when a reception intensity Lp of the wireless communication becomes equal to or lower than a threshold value Lthr, a value to he determined as the threshold value Lthr is increased as a movement speed V of the mobile station (10) increases (STEP 7),

### TECHNICAL FIELD

The present invention relates to a wireless communication system in which a mobile station executes handover from a base station communicating with the mobile station to another base station when the reception intensity of the wireless communication becomes equal to or lower than a threshold value.

### BACKGROUND ART

Conventionally, among wireless communication systems, one disclosed in Patent Literature 1 has been known. This wireless communication system includes a mobile station, a macro cell base station and a small cell base station, for example. In the wireless communication system, while wireless communication is being executed between the mobile station and the macro cell base station and in a case where handover from the macro cell base station to the small cell base station is requested to the base station, the macro cell base station estimates the movement speed of the mobile station when the frequency of the small cell base station estimated as existing in vicinity of the base station is different from that of the macro cell base station. Based on the movement speed, the value to be determined as the number of cell search trials to be executed by the mobile station is increased as the movement speed decreases.

In the mobile station, cell searches are executed based on the number of cell search trials determined by the macro cell base station. In this case, when a state in which the reception intensity of radio waves from the small cell base station is higher than a threshold value A occurs even just once, it is judged that the handover is possible. Also, when the reception intensity exceeds a threshold value B that is lower than the threshold value A in all of the cell searches, it is judged that e handover is possible. Otherwise, it is judged that the handover is impossible.

### CITATION LIST

### Patent Literature

Patent Literature 1: Japanese Patent Laid-Open No. 2014-143651

### SUMMARY OF INVENTION

### Technical Problem

Generally, in a mobile station, there is a possibility that a state in which the movement speed largely varies occurs. For example, in a case where the mobile station is a mobile terminal, the situation is that the movement speed of the mobile station largely varies between when the mobile station is carried by a pedestrian and when the mobile station is carried/mounted on a vehicle, a train or the like. Thus, even when the number of cell search trials is detemfined based on the reception intensity as in the wireless communication system in Patent Literature 1, the value that enables handover cannot be properly determined. As a result, the failure probability/failure frequency of the handover is increased so that the merchantability is decreased.

An object of the present invention, which has been made in view of the problem, is to provide a wireless communication system that can increase the probability of handover success between a mobile station and a base station and that can enhance the merchantability.

### Solution to Problem

In order to achieve the object, the invention according to claim 1 is a wireless communication system in which a mobile station executes wireless communication with a stationary base station and executes handover with a base station different from the base station when a reception intensity of the wireless communcation becomes equal to or lower than a threshold value, wherein the threshold value is determined in accordance with a movement speed of the mobile station.

Furthermore, in order to achieve the object, the invention according to claim 2 is a wireless communication system in which a mobile station executes wireless communication with a base station and executes handover with a base station different from the base station when a reception intensity of the wireless communication becomes equal to or lower than a threshold value, wherein the threshold value is determined in accordance with a movement speed of the mobile station.

According to the wireless communication system, a threshold value is determined in accordance with a movement speed of the mobile station, and handover is executed between the mobile station and another base station when a reception intensity of the wireless communication becomes equal to or lower than the threshold value. Thus, even when the degree of change of the movement speed of the mobile station is large, the threshold value can be properly determined in accordance with it, which can increase the probability of handover success. As a result, the merchantability can be enhanced.

The invention according to claim 3 is the wireless communication system according to claim 1 or 2, wherein a value to be detei mined as the threshold value is increased as the movement speed of the mobile station increases.

According to the wireless communication system, because a value to be determined as the threshold value is increased as the movement speed of the mobile station increases, the probability of handover success can he held at a high value even under condition that the reception intensity easily changes due to a high movement speed.

The invention according to claim 4 is the wireless communication system according to any one of claims 1 to 3, wherein the threshold value is corrected in accordance with a parameter indicating a change in at least one of a distance between the mobile station and the base station executing wireless communication with the mobile station and a direction of the mobile station with respect to the base station.

According to the wireless communication system, because the threshold value is corrected in accordance with a parameter indicating a change in at least one of a distance between the mobile station and the base station executing wireless communication with the mobile station and a direction of the mobile station with respect to the base station, the accuracy of the determination of the threshold value can further be increased, and the probability of handover success can further be increased.

The invention according to claim 5 is the wireless communication system according to any one of claims 1 to 4, wherein the threshold value is determined in the base station executing wireless communication with the mobile station and is transmitted from the base station to the mobile station.

According to the wireless communication system, because the threshold value is determined in the base station executing wireless communication with the mobile station and is transmitted from the base station to the mobile station, the necessity for computing of the threshold value is eliminated in the mobile station so that the computing load on the mobile station can be reduced and, because of that, the production cost of the mobile station can be reduced.

The invention according to claim 6 is the wireless communication system according to any one of claims 1 to 4, wherein the threshold value is determined in a mobility management entity communicably connected to the base station executing wireless communication with the mobile station and is transmitted from the mobility management entity to the mobile station through the base station.

According to the wireless communication system, the threshold value is determined in a mobility management entity communicably connected to the base station executing wireless communication with the mobile station and is transmitted from the mobility management entity to the mobile station through the base station. Thus, the necessity for computing of the threshold value is eliminated in the mobile station so that the computing load on the mobile station can be reduced and, because of that, the production cost of the mobile station can be reduced.

### BRIEF DESCRIPTION OF DRAWINGS

FIG. 1 is a diagram showing a configuration of a wireless communication system according to one embodiment of the present invention.

FIG. 2 is a block diagram showing an electrical configuration of a mobile station.

FIG. 3 is a block diagram showing an electrical configuration of a base station.

FIG. 4 is a diagram showing an example of communication operations upon start of an engine of a vehicle.

FIG. 5 is a flowchart showing threshold value information determine processing.

FIG. 6 is a diagram showing an example of communication operations while the vehicle is running.

FIG. 7 is a diagram showing an example of a map for calculating a threshold value Lthr.

FIG. 8 is a diagram showing an example of a map for calculating a correction coefficient KLp.

### DESCRIPTION OF EMBODIMENT

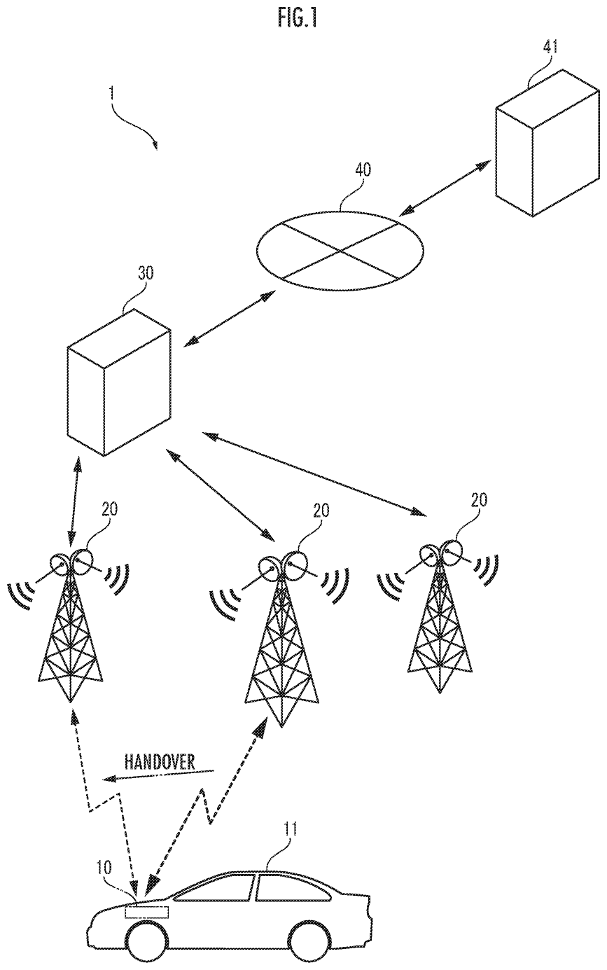

With reference to drawings, a wireless communication system according to an embodiment of the present invention is described below. A wireless communication system 1 shown in FIG. 1 of this embodiment is a high-speed wireless communication system based on a predetermined standard (fifth-generation mobile communications system: 5G) and includes a mobile station (UE) 10, many base stations (eNBs) 20 (only three of which are shown) and many mobility management entities (MMES) 30 (only one of which is shown).

The mobile station 10 is mounted on a vehicle 11 and executes wireless communication with each of the base stations 20 based on radio resource control (RRC) protocol, as is described below.

A plurality of base stations 20 are connected to each of the mobility management entities 30 and execute data communication through a predetermined communication protocol (such as TCP/IP protocol or IP protocol). The mobility management entities 30 are further connected to a server 41 and so on over a network 40.

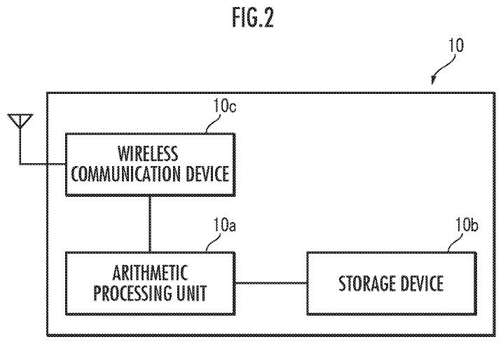

Next, with reference to FIG. 2, a configuration of the mobile station 10 is described. As shown in FIG. 2, the mobile station 10 comprises an arithmetic processing unit 10a, a storage device 10b, and a wireless communication device 10c, for example. The arithmetic processing unit 10a is configured by, for example, a CPU and, through the wireless communication device 10c, executes wireless communication control processing that transmits and receives a communication data sigmil to and from the base station 20 based on RRC protocol and calculates a reception intensity Lp (unit: dBm, for example) caused when the communication data signal is received, as is described below.

Furthermore, an (not shown) mounted on the vehicle 11 is electrically connected to the arithmetic processing unit 10a. The arithmetic processing unit 10a receives various kinds of data such as a vehicle speed from the ECU and sets the vehicle speed as a movement speed V of the mobile station 10.

The storage device 10b is configured by, for example, a RAM, a ROM and an E2PROM and stores various kinds of data such as the reception intensity Lp calculated by the arithmetic processing unit 10a, various kinds of data transmitted and received to and front the base station 20 and various kinds of data received from the ECU, for example.

The wireless communication device 10c is configured by, for example, a wireless circuit comprising a modem chip that can execute wireless communication based on RRC protocol.

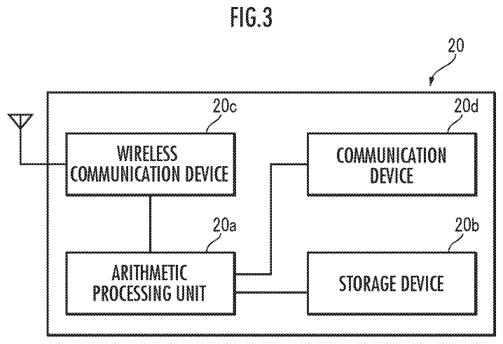

Next, with reference to FIG. 3, a configuration of the base station 20 is described. As shown in FIG. 3, the base station 20 comprises an arithmetic processing unit 20a, a storage device 20b, a wireless communication device 20c, and a communication device 20d, for example.

The arithmetic processing unit 20a is configured by, for example, a CPU, and, through the wireless communication device 20c, executes wireless communication control processing that transmits and receives a communication data signal to and from the mobile station 10 based on RRC protocol, as is described below. Through the communication device 20d, the arithmetic processing unit 20a executes data communication based on the above-described predetermined communication protocol with the mobility management entity 30.

Furthermore, the arithmetic processing unit 20a executes various kinds of control processing such as threshold value information determine processing, as is described below.

On the other hand, the storage. device 20b is configured by, for example, a RAM, a ROM, and an E2PROM and stores, for example, data included in communication data signals received from the mobile station 10 and the mobility management entity 30.

The wireless communication device 20c is configured by, for example, a modem chip and a wireless circuit that can execute wireless communication based on RRC protocol, and the communication device 20d is configured by, for example, a communication circuit that can execute data communication based on the above-described predetermined communication protocol.

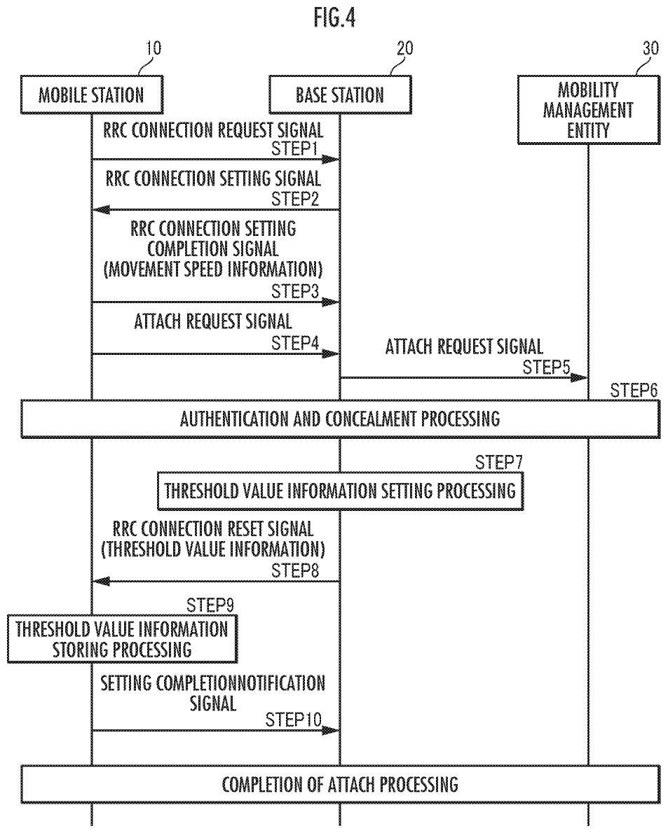

Next, with reference to FIG. 4, communication operations by the wireless communication system l of this embodiment are described. FIG. 4 shows communication operations upon start of an engine of the vehicle 11, that is, when the wireless communication system 1 is powered on.

As shown in FIG, 4, first, in order to connect the mobile station 10 to the base station 20, an RRC connection request signal (RRC Connection Request) is transmitted from the mobile station 10 to the base station 20 (FIG. 4/STEP 1).

In response to reception of the RRC connection request signal, an RRC connection setting signal (RRC Connection Setup) is transmitted from the base station 20 to the mobile station 10 (FIG. 4/STEP 2). Next, in order to indicate that the connection between the mobile station 10 and the base station 20 has been completed, an RRC connection setting completion signal (RRC Connection Setup Complete) is transmitted from the mobile station 10 to the base station 20 (FIG. 4/STEP 3).

The RRC connection setting completion signal includes movement speed information indicating a movement speed V of the mobile station 10. In this case, because the communication operations in FIG. 4 are operations upon start of the engine, the vehicle 11 has a stop state, and, therefore, movement speed V=0.

Next, in order to register the mobile station 10 with the network of the wireless communication system 1, an attach request signal (Attach Request) is transmitted from the mobile station 10 to the base station 20 (FIG. 4/STEP 4). In response thereto, the attach request signal is transmitted from the base station 20 to the mobility management entity 30 (FIG. 4/STEP 5).

After the execution of the communication operations described above, authentication and concealment processing is executed among the mobile station 10, the base station 20 and the mobility management entity 30 (FIG. 4/STEP 6). Thus, the mobile station 10 is registered with the network of the wireless communication system 1.

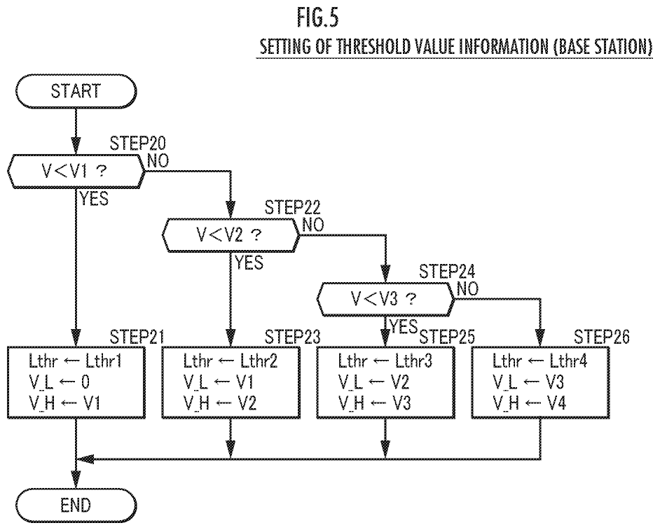

Next, the threshold value information determine processing is executed in the base station 20 (FIG. 4/STEP 7). The threshold value information determine processing determines/sets three values (threshold value Lthr of the reception intensity Lp, lower limit speed V_L, higher limit speed V_H) to be used in handover judging processing, which is described below, and, specifically, is executed as shown in FIG. 5.

First, whether the movement speed V is lower than a first predetermined speed V1 or not is judged (FIG. 5/STEP 20). This first predetermined speed V1 is set to a value (such as 30 km/h) defining a higher limit of a low-speed area.

If this judgement is positive (FIG. 5/YES in STEP 20), it is judged that, the movement speed V is in the low-speed area, and the threshold value Lthr, the lower limit speed V_L and the higher limit speed V_H are set to a first predetermined value Lthr1, a value 0 and the first predetermined speed V1, respectively (FIG. 5/STEP 21). Then, the processing ends.

On the other hand, if the above-described judgement is negative (FIG. 5/NO in STEP 20), that is, if a relationship of V1≤V is satisfied, whether the movement speed V is lower than a second predetermined speed V2 or not is judged (FIG. 5/STEP 22). This second predetermined speed V2 is set to a value (such as 60 km/h) that is higher than the first predetermined speed V1 and defines a higher limit of a middle-speed area.

If this judgement s positive (FIG. 5/YES in STEP 22), that is, if a relationship of V1≤V<V2 is satisfied, it is judged that the movement speed V is in the middle speed area, and the threshold value Lthr, the lower limit speed V_L and the higher limit speed V_H are set to a second predetermined value Lthr2, the first predetermined speed V1 and the second predetermined speed V2, respectively (FIG. 5/STEP 23). Then, the processing ends. This second predetermined value Lthr2 is set such that a relationship of Lthr1<Lthr2 can be satisfied.

On the other hand, if the above-described judgement is negative (FIG. 5/NO in STEP 22), that is, if a relationship of V2≤V is satisfied, whether the movement speed V is lower than a third predetermined speed V3 or not is judged (FIG. 5/STEP 24). This third predetermined speed V3 is set to a value (such as 120 km/h) that is higher than the second predetermined speed V2 and defines a higher limit of a high-speed area.

If this judgement is positive (FIG. 5/YES in STEP 24), that is, a relationship of V2≤V<V3 is satisfied, it is judged that the movement speed V is in the high-speed area, and the threshold value Lthr, the lower limit speed V_L and the higher limit speed V_H are set to a third predetermined value Lthr3, the second predetermined speed V2 and the third predetermined speed V3, respectively (FIG. 5/STEP 25). Then, the processing ends. This third predetemlined value Lthr3 is set such that a relationship of Lthr2<Lthr3 can be satisfied.

On the other hand, if the above-described judgement is negative (FIG. 5/NO in STEP 24), that is, if a relationship of V3≤V is satisfied, it is judged that the movement speed V is in an ultra-high-speed area, and the threshold value Lthr, the lower limit speed and the higher limit speed are set to a fourth predetermined value Lthr4, the third predetermined speed V3 and a fourth predetermined speed V4, respectively (FIG. 5/STEP 26). Then, the processing ends. This fourth predetermined value Lthr4 is set such that a relationship of Lthr3<Lthr4 can be satisfied, and the fourth predetermined speed V4 is set such that a relationship of V3<V4 (≈ ∞) can be satisfied.

Referring back to FIG. 4, after the threshold value information determine processing (FIG. 4/STEP 7) is executed in the base station 20 in the manner described above, an RRC connection reset signal (RRC connection reconfiguration) including the threshold value information determined in the processing is transmitted from the base station 20 to the mobile station 10 (FIG. 4/STEP 8).

In response thereto, threshold value information storing processing is executed in the mobile station 10 (FIG. 4/STEP 9). In this processing, the threshold value Lair, the lower limit speed V_L and the higher limit speed V_H are stored within the storage device 10b in the mobile station 10.

Next, an RRC connection reset completion signal (RRC connection reconfiguration Complete) is transmitted from the mobile station 10 to the base station 20 (FIG. 4/STEP 10). Thus, the attach processing completes, and a state in which the mobile station 10 is registered with the network of the wireless communication system 1 is acquired.

In the communication operation processing in FIG. 4 described above, the threshold value information determine processing in STEP 7 may be executed upon origination (Idle to Active). In this case, an origination request signal (PDN Connectivity request) may be transmitted from the mobile station 10 to the base station 20 in STEP 4, the origination request signal (PDN Connectivity request) may be transmitted from the base station 20 to the mobility management entity 30 in STEP 5, and after the authentication and concealment processing is executed in STEP 6, the threshold value information determine processing in STEP 7 may be executed.

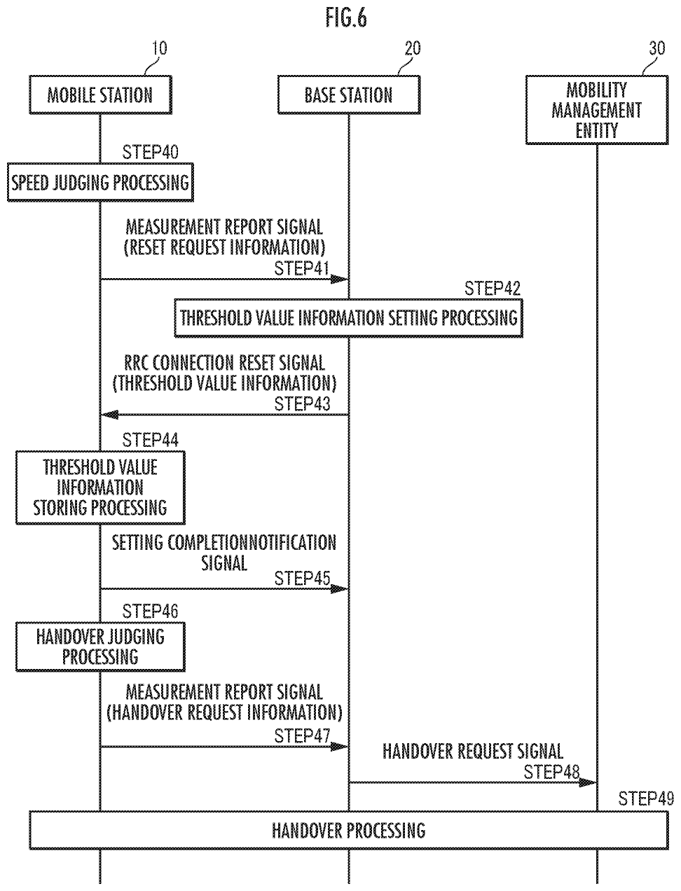

Next, with reference to FIG. 6, communication operations by the wireless communication system 1 while the vehicle 11 is running are described.

As shown in FIG. 6, first, speed judging processing is executed in the mobile station 10 (FIG. 6/STEP 40). Though not shown, in this speed judging processing, a movement speed. V is read from the ECU, and whether the movement speed V is in a speed area of V_L≤V<V_H or not is judged.

If the movement speed V is not in the speed area of V_L≤V<V_H, that is, if a relationship of V<V_L or V_H≤V is satisfied, it is judged that requesting reset of the threshold value Lthr is necessary, and a measurement report signal (Measurement Report) including reset request information for requesting it is transmitted from the mobile station 10 to the base station 20 (FIG. 6/STEP 41).

Thus, the threshold value information determine processing in FIG. 5 described above is executed in the base station 20 (FIG. 6/STEP 42).

Next, as described above, the RRC connection reset signal (RRC connection reconfiguration) including the threshold value information is transmitted from the base station 20 to the mobile station 10 (FIG. 6/STEP 43).

In response thereto, the threshold value information storing processing is executed in the mobile station 10 (FIG. 6/STEP 44) as described above. In other words, the threshold value Lthr, the lower limit speed V_L and the higher limit speed are stored within the storage device 10b in the mobile station 10.

After that, as described above, the RRC connection reset completion signal (RRC connection reconfiguration Complete) is transmitted from the mobile station 10 to the base station 20 (FIG. 6/STEP 45).

Next, handover judging processing is executed in the mobile station 10 (FIG. 6/STEP 46). Though not shown, in this handover judging processing, a reception intensity Lp of a signal received from the base station 20 is calculated, and whether it is higher than the threshold value Lthr or not is judged.

While nothing is executed if a relationship of Lp>Lthr is satisfied, it is judged that handover is to be executed if a relationship of L≤Lthr is satisfied, and a measurement report signal (Measurement Report) including handover request information for requesting execution of handover is transmitted from the mobile station 10 to the base station 20 (FIG. 61/STEP 47).

Next, a handover request. signal (Handover Request) is transmitted from the base station 20 to the mobility management entity 30 (FIG. 6/STEP 48). Thus, handover processing is executed among the mobility management entity 30, another base station 20 and the mobile station 10 (FIG. 6/STEP 49).

In this manner, according to the wireless communication system 1 of this embodiment, the threshold value information determine processing is executed in the base station 20. In this threshold value information determine processing, a threshold value Lthr, a higher limit speed V_H and a lower limit speed V_L are determined in accordance with the movement speed V of the mobile station 10. In a case where the movement speed V is in an area equal to or higher than the higher limit speed and lower than the lower limit speed and when the reception intensity Lp in the mobile station 10 becomes equal to or lower than the threshold value Lthr, handover is executed between the mobile station 10 and the other base station 20 (FIG. 6/STEPs 42 to 49).

Therefore, even when the degree of change of the movement speed V of the mobile station 10 is large, the threshold value Lthr can be properly deteimined in accordance with it, which can increase the probability of handover success. Thus, the merchantability can be enhanced. Because the value to be set as the threshold value Lthr is increased as the speed area of the movement speed V of the mobile station 10 increases, the probability of handover success can be held at a high value even under condition that the reception intensity Lp easily changes due to a high movement speed V.

Furthermore, because the threshold value Lthr is determined in the base station 20 executing wireless communication with the mobile station 10 and is transmitted from the base station 20 to the mobile station 10, the necessity for computing of the threshold value Lthr is eliminated in the mobile station 10 so that the computing load on the mobile station 10 can be reduced and, because of that, the production cost of the mobile station 10 can be reduced.

Although this embodiment is an example in which the threshold value Lthr is determined in accordance with the movement speed V of the mobile station 10 by the technique shown in FIG. 5, the threshold value determine technique of the present invention is not limited thereto but it may only be required that a threshold value is determined in accordance with the movement speed of a mobile station.

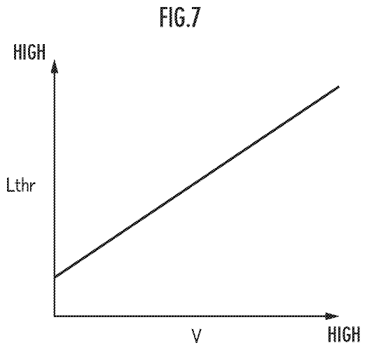

For example, the threshold value Lthr may be determined by searching through a map shown in FIG. 7 in accordance with the movement speed V of the mobile station 10. On this map, a value to be set as the threshold value Lthr is increased as the movement speed V increases. This is for addressing a large degree of change of the reception intensity Lp because the degree of change of the reception intensity Lp increases as the movement speed V increases.

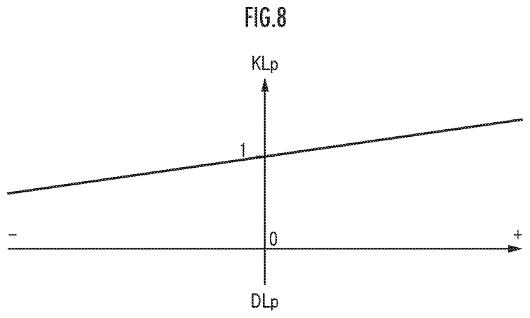

The threshold valueLthr determined in the manner described above may be corrected for use as follows. That is, in the mobile station 10, a deviation DLp between the current value and the last value of the reception intensity is calculated, and a correction coefficient KLp is calculated by searching through a map shown in FIG. 8 in accordance with the deviation DLp. Then, a product KLp*Lthr of the correction coefficient KLp and the threshold value Lthr determined by the technique in FIG. 5 or the map search in FIG. 7 for a value acquired by correcting the threshold value Lthr with the correction coefficient KLp) may be compared with the reception intensity Lp.

As shown in FIG. 8, the value to be set as the correction coefficient KLp is increased as the deviation DLp increases. This is because of the following reason. That is, because the deviation DLp is calculated as a deviation between the current value and the last value of the reception intensity, the deviation DLp corresponds to a parameter indicating a change in distance between the mobile station 10 and the base station 20 executing wireless communication with the mobile station 10 and/or a change in direction of the mobile station 10 with respect to the base station 20.

Therefore, because of use of the value KLp*Lthr corrected in accordance with the deviation DLp in the manner described above as the threshold value to be compared with the reception intensity Lp, the accuracy of the determination of the threshold value can further be increased by properly reflecting a change in distance between the mobile station 10 and the base station 20 and/or a change in direction of the mobile station 10 with respect to the base station 20. As a result, the probability of handover success can further be increased. Note that the above-described calculation of the correction coefficient KLp may be executed in the base station 20.

Although this embodiment is an example in which the mobile station 10 mounted on the vehicle 11 is used as a mobile station, the mobile station of the present invention is not limited thereto, but the mobile station may be anything that executes wireless communication with a base station and executes handover with another base station when the reception intensity of the wireless communication becomes equal to or lower than a threshold value. For example, a mobile terminal such as a mobile phone, a smart phone and a tablet terminal may be used as the mobile station.

Although this embodiment is an example in which the threshold value information determine processing is executed in the base station 20, the threshold value information determine processing may be executed in the mobility management entity 30, and the threshold value information determined in the mobility management entity 30 may be transmitted to the mobile station 10 through the base station 20. The threshold value Lthr may be determined by using the above-described map in FIG. 7 when the threshold value information determine processing is executed in the mobility management entity 30, or the threshold value Lthr may be corrected with the correction coefficient KLp calculated from the map shown in FIG. 8, and the corrected value KLp*Lthr may be determined as a threshold value.

On the other hand, although this embodiment is an example in which, in the mobile station 10, the movement speed V is set as the vehicle speed received from the ECU of the vehicle 11, the movement speed V may be calculated in the mobile station 10 based on a detection signal from, for example, an acceleration sensor included in the mobile station 10 instead of that.

Although this embodiment is an example in whiCh the RRC connection setting completion signal transmitted from the mobile station 10 to the base station 20 includes movement speed information, a signal of the movement speed information may be directly transmitted from the mobile station 10 to the base station 20 instead of that.

### REFERENCE SIGNS LIST

1 wireless communication system

10 mobile station

20 base station

30 mobility management entity

V movement speed

Lp reception intensity

Lthr threshold value

DLp deviation (parameter indicating a change in at least one of a distance between a mobile station and the base station 20 and a direction of the mobile station with respect to the base station)

1. A wireless communication system in which a mobile station executes wireless communication with a stationary base station and executes handover with a base station different from the base station when a reception intensity of the wireless communication becomes equal to or lower than a threshold value, wherein
the threshold value is determined in accordance with a movement speed of the mobile station.

2. A wireless communication system in which a mobile station executes wireless communication with a base station and executes handover with a base station different from the base station when a reception intensity of the wireless communication becomes equal to or lower than a threshold value, wherein
the threshold value is determined in accordance with a movement speed of the mobile station.

3. The wireless communication system according to claim 1, wherein a value to be determined as the threshold value is increased as the movement speed of the mobile station increases.

4. The wireless communication system according to claim 1, wherein the threshold value is corrected in accordance with a parameter indicating a change in at least one of a distance between the mobile station and the base station executing wireless communication with the mobile station and a direction of the mobile station with respect to the base station.

5. The wireless communication system according to claim 1, wherein the threshold value is determined in the base station executing wireless communication with the mobile station and is transmitted from the base station to the mobile station.

6. The wireless communication system according to claim 1, wherein the threshold value is determined in a mobility management entity communicably connected to the base station executing wireless communication with the mobile station and is transmitted from the mobility management entity to the mobile station through the base station.

7. The wireless communication system according to claim 2, wherein a value to be determined as the threshold value is increased as the movement speed of the mobile station increases.

8. The wireless communication system according to claim 2, wherein the threshold value is corrected in accordance with a parameter indicating a change in at least one of a distance between the mobile station and the base station executing wireless communication with the mobile station and a direction of the mobile station with respect to the base station.

9. The wireless communication system according to claim 2, wherein the threshold value is determined in the base station executing wireless communication with the mobile station and is transmitted from the base station to the mobile station.

10. The wireless communication system according to claim 2, wherein the threshold value is determined in a mobility management entity communicably connected to the base station executing wireless communication with the mobile station and is transmitted from the mobility management entity to the mobile station through the base station.
